(19) United States
(12) Patent Application Publication
(10) Pub. No.: US 2020/0072792 A1
(43) Pub. Date: Mar. 5, 2020

(54) PARTICLE COUNTER

(71) Applicant: NGK INSULATORS, LTD., Nagoya-City (JP)

(72) Inventors: Keiichi KANNO, Nagoya-City (JP); Hidemasa Okumura, Nagoya-City (JP); Kazuyuki Mizuno, Nagoya-City (JP)

(73) Assignee: NGK INSULATORS, LTD., Nagoya-City (JP)

(21) Appl. No.: 16/677,937

(22) Filed: Nov. 8, 2019

Related U.S. Application Data
(63) Continuation of application No. PCT/JP2018/018691, filed on May 15, 2018.

(30) Foreign Application Priority Data
May 15, 2017 (JP) 2017-096234

(51) Int. Cl. G01N 27/70; G01N 15/06

(52) U.S. Cl. CPC G01N 27/70; G01N 15/0656

(57) ABSTRACT

A particle counter includes an electric-charge generating element that adds electric charges generated by discharge to particles in a gas introduced into a gas flow pipe to form charged particles, a charged-particle collection unit that is disposed downstream of the electric-charge generating element in a direction of a flow of the gas and collects the charged particles, and a number detection unit that detects the number of the charged particles based on a physical quantity at the charged-particle collection unit, wherein the gas flow pipe has a skeleton-forming portion that is formed of a ceramic material and that is dense and a stress-relieving portion that is in contact with the skeleton-forming portion, that is formed of a material having a Young's modulus lower than a Young's modulus of the ceramic material, and that is dense.

### BACKGROUND OF THE INVENTION

### 1. Field of the Invention

The present invention relates to a particle counter.

### 2. Description of the Related Art

In one known particle counter, particles in a gas introduced into a ceramic gas flow pipe are charged with ions generated by corona discharge using an electric-charge generating element, a collection electrode collects the charged particles, and a number counter measures the number of particles based on the quantity of electric charge on the collected particles (see, for example, PTL 1).

### CITATION LIST

### Patent Literature

PTL 1: WO 2015/146456 A

### SUMMARY OF THE INVENTION

However, when the number of particles in a high-temperature gas is measured using such a particle counter, a crack may occur due to thermal shock if water adheres to a ceramic gas flow pipe. A crack can result in reduced measurement accuracy not only when it penetrates the wall of the gas flow pipe but also when it does not penetrate the wall of the gas flow pipe. Specifically, when a crack not penetrating the wall of the gas flow pipe occurs, the wall of the gas flow pipe is deformed by the stress released by the crack, and an electric-charge generating element mounted to the wall is displaced. In a non-uniform electric field required to generate corona discharge, the distribution of lines of electric force is concentrated at an end portion, and thus any deformation may cause a great change in electric field distribution. This is accompanied by a change in spatial distribution of ion density, and as a result, the amount of ion adhering to one particle deviates from the range of design values, thus resulting in reduced measurement accuracy.

The present invention has been made to solve these problems, and it is a primary object thereof to prevent displacement of an electric-charge generating element.

A particle counter according to the present invention includes an electric-charge generating element that adds electric charges generated by discharge to particles in a gas introduced into a gas flow pipe to form charged particles; a charged-particle collection unit that is disposed downstream of the electric-charge generating element in a direction of a flow of the gas and collects the charged particles; and a number detection unit that detects the number of the charged particles based on a physical quantity at the charged-particle collection unit, the physical quantity varying depending on the number of the charged particles collected by the charged-particle collection unit, wherein the gas flow pipe has a skeleton-forming portion that is formed of a ceramic material and that is dense and a stress-relieving portion that is in contact with the skeleton-forming portion, that is formed of a material having a Young's modulus lower than a Young's modulus of the ceramic material, and that is dense. Alternatively, a particle counter according to the present invention includes an electric-charge generating element that adds electric charges generated by discharge to particles in a gas introduced into a gas flow pipe to form charged particles; an excess-electric-charge collection unit that is disposed downstream of the electric-charge generating element in a direction of a flow of the gas and collects excess electric charges that have not charged the particles; and a number detection unit that detects the number of the charged particles based on a physical quantity at the excess-electric-charge collection unit, the physical quantity varying depending on the number of the excess electric charges collected by the excess-electric-charge collection unit, wherein the gas flow pipe has a skeleton-forming portion that is formed of a ceramic material and that is dense and a stress-relieving portion that is in contact with the skeleton-forming portion, that is formed of a material having a Young's modulus lower than a Young's modulus of the ceramic material, and that is dense.

In this particle counter, the electric-charge generating element adds electric charges generated by discharge to particles in a gas introduced into a gas flow pipe to form charged particles. The charged-particle collection unit collects the charged particles, and the number detection unit detects the number of particles in the gas based on a physical quantity at the charged-particle collection unit, the physical quantity varying depending on the number of charged particles collected by the charged-particle collection unit. Alternatively, the excess-electric-charge collection unit collects excess electric charges, and the number detection unit detects the number of charged particles based on a physical quantity at the excess-electric-charge collection unit, the physical quantity varying depending on the number of excess electric charges collected by the excess-electric-charge collection unit. The gas flow pipe has a skeleton-forming portion that is formed of a ceramic material and that is dense and a stress-relieving portion that is in contact with the skeleton-forming portion, that is formed of a material having a Young's modulus lower than that of the ceramic material forming the skeleton-forming portion, and that is dense. With this configuration, the entire gas flow pipe is dense, and thus the gas containing the particles cannot pass through the wall of the gas flow pipe. When the number of particles in a high-temperature gas is measured, if water adheres to the gas flow pipe, the part where water adheres is rapidly cooled, and energy due to thermal shock is generated. However, the stress-relieving portion of the gas flow pipe reduces the energy density, and thus the stress concentration can be reduced to suppress the occurrence of cracking in the gas flow pipe. This can prevent displacement of the electric-charge generating element due to cracking, and hence the measurement accuracy can be maintained at a high level.

As used herein, the term “electric charges” is meant to include ions as well as positive charges and negative charges. The phrase “detecting the number of particles” is meant to include not only measuring the number of particles but also determining whether the number of particles is within a predetermined numerical range (e.g., whether the number exceeds a predetermined threshold). The “physical quantity” may be any parameter that varies depending on the number of charged particles (the electric charge quantity), and examples of such parameters include current. The phrase “being dense” refers to having an open porosity of 5% or less (preferably 3% or less, more preferably 1% or less).

In the particle counter of the present invention, the skeleton-forming portion may be constituted by divided members formed by dividing the gas flow pipe into a plurality of parts, and the stress-relieving portion may be constituted by joining layers that join the plurality of divided members together. In this configuration, the gas flow pipe is fabricated by joining together the plurality of divided members with the joining layers, and thus the gas flow pipe is easily produced. The gas flow pipe may be a quadrangular cylinder, and the divided members may be formed by dividing the gas flow pipe into four parts on four sides. In this configuration, the divided members are planar members and are allowed to expand and contract in the planar direction by the joining layers constituting the stress-relieving portion, and thus the occurrence of cracking in the gas flow pipe can be more effectively suppressed.

In the particle counter of the present invention, the skeleton-forming portion may be a tubular body equal in shape to the gas flow pipe, and the stress-relieving portion may be disposed as a layer at at least one of an outer surface, an inner surface, and an inner part of the tubular body. When the number of particles in a high-temperature gas is measured, thermal shock energy is generated if water adheres to the gas flow pipe, but the energy density is at least partially reduced by the stress-relieving portion. When the stress-relieving portion is disposed as a layer at an outer surface of the tubular body, the stress-relieving portion also serves to protect the gas flow pipe. When the stress-relieving portion is disposed as a layer at an inner part of the tubular body, the stress-relieving portion is particularly unlikely to peel off the tubular body.

In the particle counter of the present invention, the Young's modulus of the stress-relieving portion is preferably not more than 0.7 times the Young's modulus of the ceramic material forming the skeleton-forming portion. This can sufficiently reduce thermal stress that may be generated when water adheres to the gas flow pipe.

In the particle counter of the present invention, the skeleton-forming portion is preferably formed of at least one ceramic material selected from the group consisting of alumina, silicon nitride, mullite, cordierite, and magnesia. The stress-relieving portion is preferably formed of crystallized glass. The particle counter of the present invention is typically mounted to an exhaust pipe formed of a metal material, and thus thermal stress can be reduced if the skeleton-forming portion is formed of a material having a CTE close to that (10 ppm/° C. or more) of the metal material. In this respect, magnesia is suitable as a material for the skeleton-forming portion. In the particle counter of the present invention, the electric-charge generating element and the charged-particle collection unit (or the excess-electric-charge collection unit) are provided with electrodes having conductivity. The material for the electrodes may be, for example, an electrical conducting material containing Pt. Among metal materials, Pt has a relatively low CTE of 10.5 ppm/° C. Thus, when an electrical conducting material containing Pt is used as a material for the electrodes, alumina may be used as a material for the skeleton-forming portion.

In the particle counter of the present invention, the charged-particle collection unit may be disposed between a pair of collection electric-field generating electrodes so that charged particles are collected when a collection voltage is applied between the pair of collection electric-field generating electrodes. The particle counter of the present invention may include, between the electric-charge generating element and the charged-particle collection unit, an excess-electric-charge removal unit that removes excess electric charges. The excess-electric-charge removal unit may be disposed between a pair of removal electric-field generating electrodes so that excess electric charges that have not been added to particles are collected when a removal voltage lower than the collection voltage is applied between the pair of removal electric-field generating electrodes.

The particle counter of the present invention is used, for example, in atmospheric environment surveys, indoor environment surveys, pollution surveys, measurement of burning particles in automobiles and the like, monitoring of environments in which particles are generated, and monitoring of environments in which particles are synthesized.

### BRIEF DESCRIPTION OF THE DRAWINGS

FIG. 1 is a sectional view illustrating a schematic configuration of a particle counter 10.

FIG. 2 is a sectional view taken along line A-A in FIG. 1.

FIG. 3 is a graph showing the relationship between Young's modulus ratio and safety factor.

FIG. 4 is a sectional view of a gas flow pipe 112.

FIG. 5 is a sectional view of a gas flow pipe 212.

FIG. 6 is a sectional view of a modification of a gas flow pipe 12.

FIG. 7 is a perspective view of an electric-charge generating element 120.

FIG. 8 is a sectional view illustrating a schematic configuration of a particle counter 310.

### DETAILED DESCRIPTION OF THE INVENTION

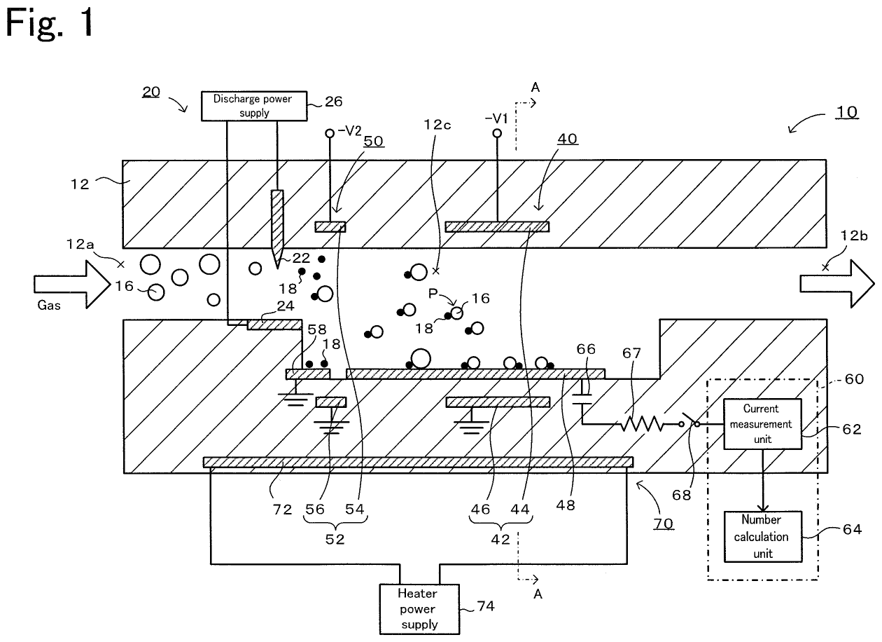

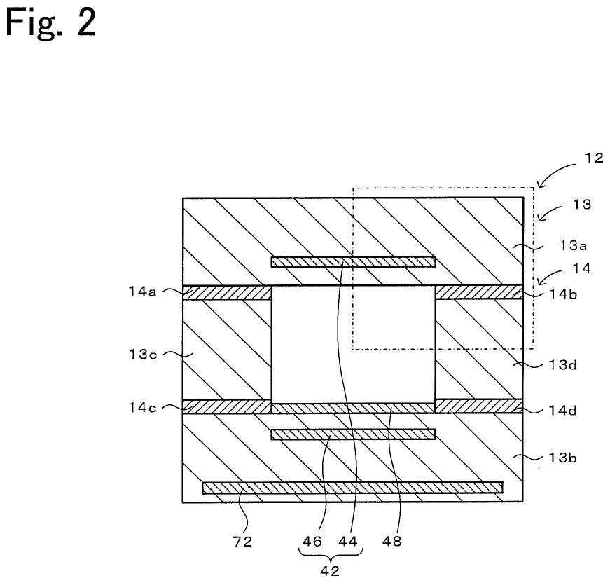

Preferred embodiments of the present invention will be described below with reference to the drawings. FIG. 1 is a sectional view illustrating a schematic configuration of a particle counter 10, and FIG. 2 is a sectional view taken along line A-A in FIG. 1.

The particle counter 10 measures the number of particles contained in a gas (e.g., an automobile exhaust gas). The particle counter 10 includes a gas flow pipe 12 made of ceramic; and an electric-charge generating element 20, a collection device 40, an excess-electric-charge removing device 50, a number measuring device 60, and a heater device 70 that are disposed in the gas flow pipe 12.

The gas flow pipe 12 has a gas inlet 12a through which a gas is introduced into the gas flow pipe 12, a gas outlet 12b through which the gas that has passed through the gas flow pipe 12 is discharged, and a hollow portion 12c that is a space between the gas inlet 12a and the gas outlet 12b. The gas flow pipe 12 is a quadrangular cylinder, that is, a tube having a quadrangular section, as illustrated in FIG. 2. The gas flow pipe 12 has a skeleton-forming portion 13 that is formed of a ceramic material and that is dense and a stress-relieving portion 14 that is in contact with the skeleton-forming portion 13, that is formed of a material having a Young's modulus lower than that of the ceramic material forming the skeleton-forming portion 13, and that is dense. The skeleton-forming portion 13 includes members formed by dividing the gas flow pipe 12 into four parts on four sides. Specifically, the skeleton-forming portion 13 includes an upper member 13a, a lower member 13b, and two sidewall members 13c and 13d. Examples of ceramic materials forming the four members 13a to 13d include, but are not limited to, alumina (Young's modulus: 280 GPa, CTE: 8.0 ppm/° C.), silicon nitride (Young's modulus: 270 GPa, CTE: 3.5 ppm/° C.), mullite (Young's modulus: 210 GPa, CTE: 5.8 ppm/° C.), cordierite (Young's modulus: 145 GPa, CTE: 0.1 ppm/° C. or less), and magnesia (Young's modulus: 245 GPa, CTE: 12.9 ppm/° C.). CTE indicates the coefficient of thermal expansion (40° C. to 850° C.) (hereinafter the same). The four members 13a to 13d are dense, and the open porosity thereof is 5% or less, preferably 3% or less, more preferably 1% or less. The stress-relieving portion 14 is constituted by joining layers 14a to 14d that join the four members 13a to 13d together. Specifically, the stress-relieving portion 14 includes the joining layer 14a that joins the upper member 13a and the sidewall member 13c together, the joining layer 14b that joins the upper member 13a and the sidewall member 13d together, the joining layer 14c that joins the lower member 13b and the sidewall member 13c together, and the joining layer 14d that joins the lower member 13b and the sidewall member 13d together. Examples of materials forming the four joining layers 14a to 14d include metals and commonly-used glass in which no crystal phases are precipitated. Crystallized glass is preferred because it has conformability when softened, which is advantageous for sealing, and it will not soften after being crystallized. Examples of crystallized glass include, but are not limited to, Neoceram (Young's modulus: 100 GPa, CTE: 0.1 ppm/° C.) and crystallized glass for SOFCs (Young's modulus: 50 to 150 GPa, CTE: 9.5 to 13.0 ppm/° C.). Crystallized glass is also referred to as glass ceramic. The four joining layers 14a to 14d are dense, and the open porosity thereof is 5% or less, preferably 3% or less, more preferably 1% or less. The difference in coefficient of thermal expansion between the skeleton-forming portion 13 and the stress-relieving portion 14 is preferably within ±1 ppm/° C., more preferably within ±0.5 ppm/° C.

A method for fabricating the gas flow pipe 12 will be described below. First, the members 13a to 13d are fabricated. Specifically, a raw powder is formed into a compact having a predetermined shape, and the compact is sintered to obtain the members 13a to 13d formed of the dense ceramic material. Electrodes and other parts are embedded before the formation. Next, a glass powder paste (a mixture of glass powder, a binder, and a solvent) is applied to joints, and the members 13a to 13d are integrated together. The integrated members are heated to a glass softening point (e.g., 500° C.) and to a thermal decomposition temperature of carbon (e.g., 600° C.) and then maintained at a higher temperature (e.g., 800° C.) to grow a crystal phase, thereby forming the joining layers 14a to 14d made of crystallized glass. The glass powder paste may be replaced with a green sheet of glass powder or a glass tablet (obtained by packing glass powder in a mold and fixing the glass powder by pressing and optionally heating). These are solid and thus are advantageous in that they are easier to handle than paste. The glass tablet contains no carbon and thus is advantageous in that pinholes and the like are unlikely to occur after heating.

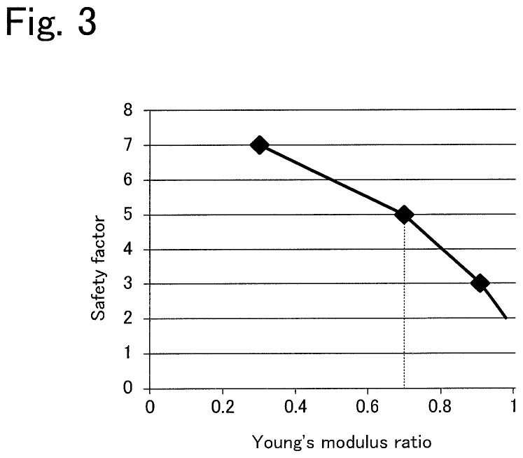

A ¼ model (the part surrounded by a dash-dot line in FIG. 2) of the gas flow pipe 12 was used to calculate thermal stress. Specifically, at an ambient temperature of 600° C., when the temperature of an area including boundaries between the skeleton-forming portion 13 (alumina, in this case) and the stress-relieving portion 14 reached 100° C. after water adhered to the area, the safety factor was determined at Young's modulus ratios of 0.9, 0.7, and 0.3. The results are shown in FIG. 3. Young's modulus ratio=Young's modulus of stress-relieving portion/Young's modulus of alumina. Safety factor=allowable stress of alumina/maximum stress. Allowable stress of alumina=2160 MPa. The maximum stresses at young's modulus ratios of 0.9, 0.7, and 0.3 were 700 MPa, 500 MPa, and 300 MPa, respectively. FIG. 3 shows that when the Young's modulus ratio is 0.7 or less, the safety factor is advantageously 5 or more.

The electric-charge generating element 20 is disposed in the gas flow pipe 12 on the side closer to the gas inlet 12a. The electric-charge generating element 20 includes a needle electrode 22 and a counter electrode 24 disposed so as to face the needle electrode 22. The needle electrode 22 and the counter electrode 24 are connected to a discharge power supply 26 that applies a voltage Vp (e.g., a pulse voltage). The counter electrode 24 is a ground electrode. When a voltage Vp is applied between the needle electrode 22 and the counter electrode 24, gaseous discharge is generated due to a potential difference between the electrodes. When a gas passes through the gaseous discharge, electric charges 18 are added to particles 16 in the gas to form charged particles P.

The collection device 40, which is a device for collecting the charged particles P, is disposed at the hollow portion 12c (downstream of the electric-charge generating element 20 in the direction of the flow of exhaust gas) in the gas flow pipe 12. The collection device 40 includes an electric-field generator 42 and a collection electrode 48. The electric-field generator 42 includes a negative electrode 44 embedded in a wall of the hollow portion 12c and a positive electrode 46 embedded in a wall facing the negative electrode 44. The collection electrode 48 is exposed on the wall of the hollow portion 12c in which the positive electrode 46 is embedded. A negative potential −V1 is applied to the negative electrode 44 of the electric-field generator 42, and a ground potential Vss is applied to the positive electrode 46. The level of the negative potential −V1 is in the range of the order of −mV to minus several tens of volts. Consequently, an electric field directed from the positive electrode 46 toward the negative electrode 44 is generated in the hollow portion 12c. Accordingly, the charged particles P that have entered the hollow portion 12c are attracted toward the positive electrode 46 under the action of the generated electric field and collected by the collection electrode 48 disposed on the way to the positive electrode 46.

The excess-electric-charge removing device 50, which is a device for removing electric charges 18 that have not been added to the particles 16, is disposed upstream of the collection device 40 in the direction of the flow of exhaust gas (between the electric-charge generating element 20 and the collection device 40) in the hollow portion 12c. The excess-electric-charge removing device 50 includes an electric-field generator 52 and a removal electrode 58. The electric-field generator 52 includes a negative electrode 54 embedded in a wall of the hollow portion 12c and a positive electrode 56 embedded in a wall facing the negative electrode 54. The removal electrode 58 is exposed on the wall of the hollow portion 12c in which the positive electrode 56 is embedded. A negative potential −V2 is applied to the negative electrode 54 of the electric-field generator 52, and a ground potential Vss is applied to the positive electrode 56. The level of the negative potential −V2 is in the range of the order of −mV to minus several tens of volts. The absolute value of the negative potential −V2 is at least one order of magnitude smaller than the absolute value of the negative potential −V1 applied to the negative electrode 44 of the collection device 40. Consequently, a weak electric field directed from the positive electrode 56 toward the negative electrode 54 is generated. Accordingly, among the electric charges 18 generated by gaseous discharge at the electric-charge generating element 20, electric charges 18 that have not been added to the particles 16 are attracted toward the positive electrode 56 under the action of the weak electric field and discarded to GND via the removal electrode 58 disposed on the way to the positive electrode 56.

The number measuring device 60, which is a device for measuring the number of the particles 16 based on the quantity of the electric charges 18 of the charged particles P collected by the collection electrode 48, includes a current measurement unit 62 and a number calculation unit 64. Between the current measurement unit 62 and the collection electrode 48, a capacitor 66, a resistor 67, and a switch 68 are connected in series from the collection electrode 48 side. The switch 68 is preferably a semiconductor switch. When the switch 68 is turned on and the collection electrode 48 and the current measurement unit 62 are electrically connected to each other, a current based on the electric charges 18 added to the charged particles P adhering to the collection electrode 48 is transmitted, as a transient response, through a series circuit constituted by the capacitor 66 and the resistor 67 to the current measurement unit 62. The current measurement unit 62 may be an ordinary ammeter. The number calculation unit 64 calculates the number of the particles 16 based on a current value from the current measurement unit 62.

The heater device 70 includes a heater electrode 72 and a heater power supply 74. The heater electrode 72 is embedded in the wall on which the collection electrode 48 is disposed. The heater power supply 74 applies a voltage between terminals at opposite ends of the heater electrode 72 to electrify the heater electrode 72, thereby heating the heater electrode 72. The heater device 70 is also used when the number of particles is measured in a state free from the influence of macromolecule hydrocarbons called SOF (Soluble Organic Fraction).

Next, an example of how the particle counter 10 is used will be described. When the number of particles contained in an automobile exhaust gas is measured, the particle counter 10 is mounted inside an exhaust pipe of an engine, such that the exhaust gas is introduced through the gas inlet 12a of the particle counter 10 into the gas flow pipe 12 and discharged through the gas outlet 12b.

When particles 16 contained in the exhaust gas introduced through the gas inlet 12a into the gas flow pipe 12 pass through the electric-charge generating element 20, electric charges 18 (electrons) are added thereto to form charged particles P, which then enter the hollow portion 12c. The charged particles P pass through the excess-electric-charge removing device 50, in which the electric field is weak and the removal electrode 58 is only 1/20 to 1/10 as long as the hollow portion 12c, without any change and reach the collection device 40. Electric charges 18 that have not been added to the particles 16 also enter the hollow portion 12c. Despite the weak electric field, such electric charges 18 that have not been added are attracted toward the positive electrode 56 of the excess-electric-charge removing device 50 and discarded to the GND via the removal electrode 58 disposed on the way to the positive electrode 56. Thus, the unnecessary electric charges 18 that have not been added to the particles 16 can hardly reach the collection device 40.

The charged particles P that have reached the collection device 40 are attracted toward the positive electrode 46 and collected by the collection electrode 48 disposed on the way to the positive electrode 46. A current based on the electric charges 18 of the charged particles P adhering to the collection electrode 48 is transmitted, as a transient response, through the series circuit constituted by the capacitor 66 and the resistor 67 to the current measurement unit 62 of the number measuring device 60.

The relationship between the current I and the electric charge quantity q is I=dq/(dt), or q=∫I dt. Therefore, the number calculation unit 64 integrates (accumulates) current values from the current measurement unit 62 over a time period during which the switch 68 is on (switch-on period) to determine the integrated current value (accumulated electric charge quantity). After the switch-on period, the accumulated electric charge quantity is divided by the elementary charge to determine the total number of electric charges (the number of collected electric charges), and the number of collected electric charges is divided by the average number of electric charges added to one particle 16, whereby the number of particles 16 that have adhered to the collection electrode 48 for a predetermined time (e.g., 5 to 15 seconds) can be determined. The number calculation unit 64 then repeatedly performs the calculation of the number of particles 16 during the predetermined time over a predetermined time period (e.g., 1 to 5 minutes) and integrates the results, whereby the number of particles 16 that have adhered to the collection electrode 48 over the predetermined time period can be calculated. By using the transient response of the capacitor 66 and the resistor 67, a small current can be measured, and the number of particles 16 can be detected with high accuracy. A very small current at a pA (picoampere) or nA (nanoampere) level can be measured, for example, by increasing the time constant by using a resistor 67 having a large resistance value.

When the number of particles 16 is measured, the measurement accuracy decreases if the exhaust gas containing the particles 16 passes through the wall of the gas flow pipe 12 and moves in and out of the gas flow pipe 12. According to this embodiment, the entire gas flow pipe 12 is dense so that the exhaust gas containing the particles 16 cannot pass through the wall of the gas flow pipe 12, and thus the measurement accuracy can be maintained at a high level. When the number of particles in a high-temperature exhaust gas is measured, if water adheres to the gas flow pipe 12, energy due to thermal shock is generated at the part where water adheres. However, the stress-relieving portion 14 (the joining layers 14a to 14d) of the gas flow pipe 12 at least partially reduces the energy density, and thus the occurrence of cracking in the gas flow pipe 12 can be suppressed. This can prevent displacement of the electric-charge generating element 20 (particularly, displacement of the tip of the needle electrode 22) due to cracking, and hence the measurement accuracy can be maintained at a high level. If the tip of the needle electrode 22 is displaced, the spatial distribution of ion density will be changed, and as a result, the average number of electric charges added to one particle 16 (a parameter used to calculate the number of particles 16) may deviate from the range of design values, resulting in reduced measurement accuracy.

After the number of particles is measured, the particles and the like may be deposited on the collection electrode 48. In this case, the heater power supply 74 is controlled so as to apply a predetermined refresh voltage between the pair of terminals of the heater electrode 72. The heater electrode 72 to which the predetermined refresh voltage has been applied is heated to a temperature that can burn up the charged particles P collected by the collection electrode 48. As a result, the collection electrode 48 can be refreshed.

Here, the correspondence relation between components of the particle counter 10 according to this embodiment and components of the particle counter of the present invention will be described. The gas flow pipe 12 in this embodiment corresponds to the gas flow pipe in the present invention. The electric-charge generating element 20 corresponds to the electric-charge generating element. The collection device 40 corresponds to the charged-particle collection unit. The number measuring device 60 corresponds to the number detection unit.

In the particle counter 10 described in detail above, the entire gas flow pipe 12 is dense so that an exhaust gas containing particles cannot pass through the wall of the gas flow pipe 12. In addition, if water adheres to the gas flow pipe 12, the stress-relieving portion 14 of the gas flow pipe 12 suppresses the occurrence of cracking, and thus displacement of the electric-charge generating element 20 due to cracking can be prevented. Therefore, the particle counter 10 can provide measurement accuracy maintained at a high level.

In addition, since the gas flow pipe 12 is fabricated by joining together the plurality of members 13a to 13d with the joining layers 14a to 14d, the gas flow pipe 12 is easily fabricated.

Furthermore, the plurality of members 13a to 13d are planar members and are allowed to expand and contract in the planar direction by the joining layers 14a to 14d, and thus the occurrence of cracking in the gas flow pipe 12 can be more effectively suppressed.

It should be understood that the present invention is not limited to the embodiment described above and can be practiced in various aspects without departing from the technical idea of the present invention.

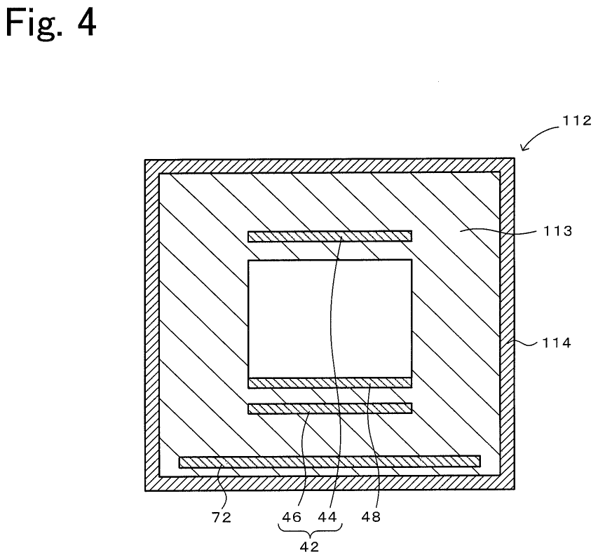

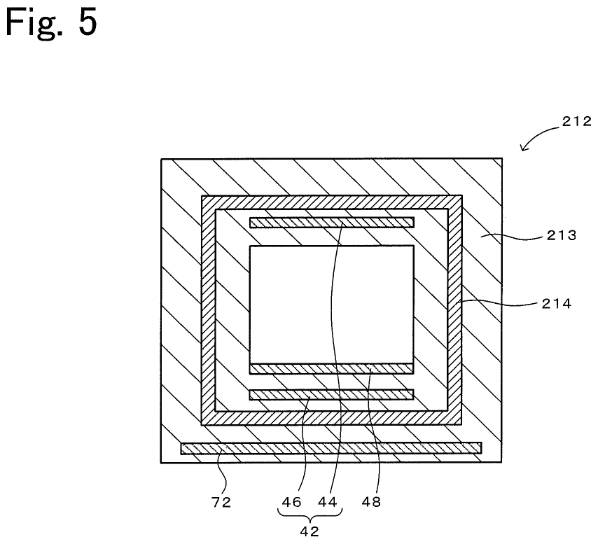

While the gas flow pipe 12 having the skeleton-forming portion 13 and the stress-relieving portion 14 has been employed in the embodiment described above, a gas flow pipe 112 or 212 illustrated in FIG. 4 or FIG. 5 may be employed alternatively. FIG. 4 is a sectional view of the gas flow pipe 112, and FIG. 5 is a sectional view of the gas flow pipe 212. These are figures corresponding to sectional views taken along line A-A in FIG. 1. The reference numerals 42, 44, 46, 48, and 72 denote the same components as in the embodiment described above, and thus descriptions thereof will be omitted.

The gas flow pipe 112 illustrated in FIG. 4 has a skeleton-forming portion 113, which is a tubular body equal in shape to the gas flow pipe 112, and a stress-relieving portion 114, which covers an outer surface of the skeleton-forming portion 113 and is in the form of a layer. The skeleton-forming portion 113 is formed of a ceramic material. Specific examples of ceramic materials are the same as set forth in the above embodiment. The stress-relieving portion 114 is formed of a material (e.g., crystallized glass) having a Young's modulus lower than that of the ceramic material forming the skeleton-forming portion 113. When the number of particles in a high-temperature gas is measured, thermal shock energy is generated if water adheres to the gas flow pipe 112, but the energy density is at least partially reduced by the stress-relieving portion 114. Thus, the occurrence of cracking in the gas flow pipe 112 can be suppressed. The stress-relieving portion 114 also serves to protect the gas flow pipe 112. Alternatively or in addition to the stress-relieving portion 114, a stress-relieving portion that covers an inner surface of the skeleton-forming portion 113 (excluding the electrodes 22, 24, 48, and 58) and that is in the form of a layer may be disposed. Also for the gas flow pipe 112, the relationship between Young's modulus ratio and safety factor was investigated as in the embodiment described above, revealing that when the Young's modulus ratio was 0.7 or less, the safety factor was 5 or more.

The gas flow pipe 212 illustrated in FIG. 5 has a skeleton-forming portion 213, which is a tubular body equal in shape to the gas flow pipe 212, and a stress-relieving portion 214, which is embedded inside the skeleton-forming portion 213 and is in the form of a layer (a thin cylinder). The skeleton-forming portion 213 is formed of a ceramic material. Specific examples of ceramic materials are the same as set forth in the above embodiment. The stress-relieving portion 214 is formed of a material (e.g., crystallized glass) having a Young's modulus lower than that of the ceramic material forming the skeleton-forming portion 213. When the number of particles in a high-temperature gas is measured, thermal shock energy is generated if water adheres to the gas flow pipe 212, but the energy density is at least partially reduced by the stress-relieving portion 214. Thus, the occurrence of cracking in the gas flow pipe 212 can be suppressed. The stress-relieving portion 214 is unlikely to peel off the skeleton-forming portion 213. In addition to the stress-relieving portion 214, the stress-relieving portion 114 illustrated in FIG. 4 may be disposed, or a stress-relieving portion that covers an inner surface of the skeleton-forming portion 213 (excluding the electrodes 22, 24, 48, and 58) and that is in the form of a layer may be disposed.

While the joining layers 14a to 14d of the gas flow pipe 12 constitute the stress-relieving portion 14 in the embodiment described above, a stress-relieving portion in the form of a layer may additionally be disposed at at least one of an outer surface, an inner surface, and an inner part of the gas flow pipe 12.

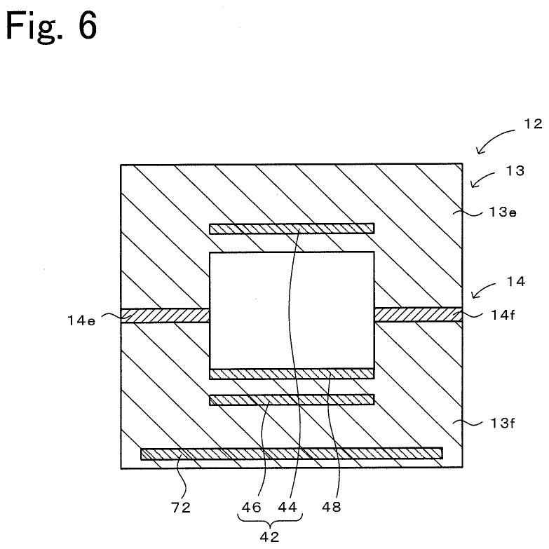

While the gas flow pipe 12 is divided into four parts in the embodiment described above, divided members 13e and 13f (a skeleton-forming portion 13) formed by dividing the gas flow pipe 12 into two upper and lower parts may be joined together with joining layers 14e and 14f (a stress-relieving portion 14), as illustrated in FIG. 6. The reference numerals 42, 44, 46, 48, and 72 in FIG. 6 denote the same components as in the embodiment described above, and thus descriptions thereof will be omitted.

While the gas flow pipe 12 is a quadrangular cylinder in the embodiment described above, the gas flow pipe 12 is not particularly limited to the quadrangular cylinder and may be a circular cylinder or a cylinder with a polygonal section. The shape of the contour of the section of the gas flow pipe 12 may be circular, and the hollow portion 12c in the section of the gas flow pipe 12 may be quadrangular. The same applies to FIG. 4 to FIG. 6.

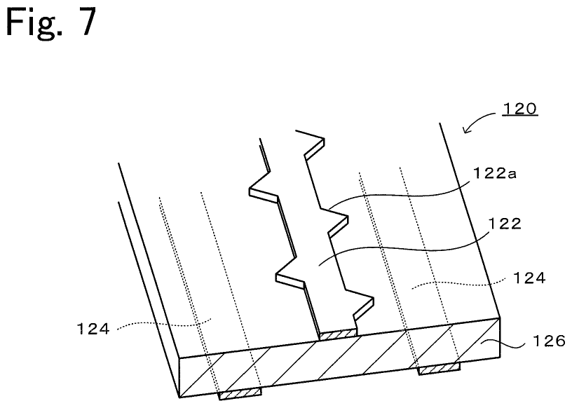

While the electric-charge generating element 20 including the needle electrode 22 and the counter electrode 24 is employed in the embodiment described above, an electric-charge generating element 120 illustrated in FIG. 7 may be employed alternatively. In the electric-charge generating element 120, a discharge electrode 122 and an ground electrode 124 are disposed on opposite surfaces of a dielectric layer 126. The discharge electrode 122 is a thin rectangular metal plate provided on its opposite long sides with a plurality of small protrusions 122a having a triangular shape. The ground electrode 124 is a rectangular electrode, and two ground electrodes 124 are disposed parallel to the longitudinal direction of the discharge electrode 122. When a high voltage with a high frequency is applied between the electrodes of the electric-charge generating element 120, discharge occurs to generate ions (electric charges).

While the number of particles is measured in the embodiment described above, whether the number of particles is within a predetermined numerical range (e.g., whether the number exceeds a predetermined threshold) may be determined alternatively.

While current is used as the parameter that varies depending on the number of charged particles (the electric charge quantity) in the embodiment described above, the parameter is not particularly limited to current, and any parameter that varies depending on the number of charged particles (the electric charge quantity) may be used.

While the excess-electric-charge removing device 50 is disposed in the embodiment described above, the excess-electric-charge removing device 50 may be omitted.

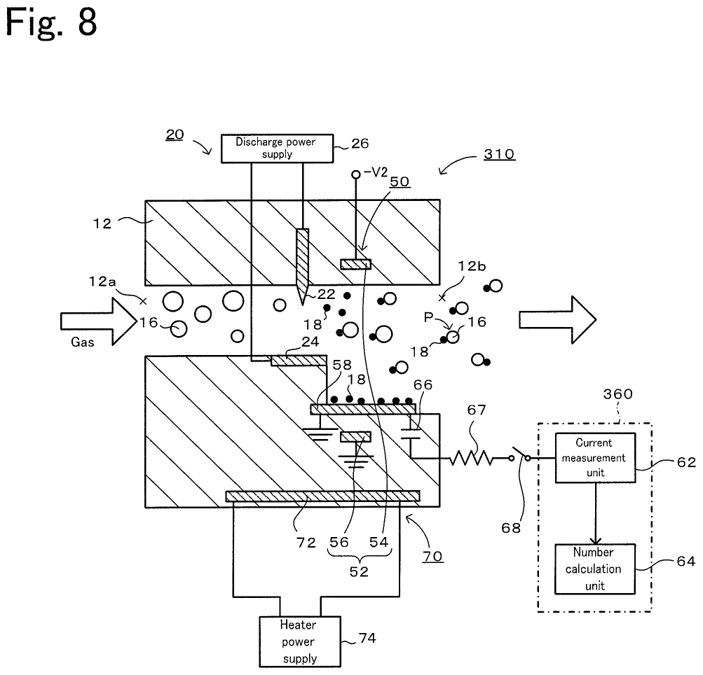

In the embodiment described above, the number of charged particles P is determined based on a current flowing through the collection electrode 48 of the collection device 40. Alternatively, as in a particle counter 310 illustrated in FIG. 8, the collection device 40 (the electric-field generator 42 and the collection electrode 48) may be omitted, and a number measuring device 360 may determine the number of charged particles P in a manner that the number of excess electric charges is determined based on a current flowing through a removal electrode 58 of an excess-electric-charge removing device 50 and the number of excess electric charges is subtracted from the total number of electric charges generated by an electric-charge generating element 20. Also in this case, a gas flow pipe 12 is configured to have a skeleton-forming portion 13 (13a to 13d) that is formed of a ceramic material and that is dense and a stress-relieving portion 14 (14a to 14d) that is in contact with the skeleton-forming portion 13, that is formed of a material having a Young's modulus lower than that of the ceramic material, and that is dense, as illustrated in FIG. 2. In the particle counter 310 having this configuration, the entire gas flow pipe 12 is dense so that an exhaust gas containing particles cannot pass through the wall of the gas flow pipe 12. In addition, if water adheres to the gas flow pipe 12, the stress-relieving portion 14 of the gas flow pipe 12 suppresses the occurrence of cracking, and thus displacement of the electric-charge generating element 20 due to cracking can be prevented. Therefore, the measurement accuracy can be maintained at a high level. As alternatives to the gas flow pipe 12 in FIG. 2, the gas flow pipe 112 in FIG. 4, the gas flow pipe 212 in FIG. 5, and the gas flow pipe 12 in FIG. 6 may be employed.

The present application claims priority on the basis of the Japanese Patent Application No. 2017-096234 filed on May 15, 2017, the entire contents of which are incorporated herein by reference.

What is claimed is:

1. A particle counter comprising:
an electric-charge generating element that adds electric charges generated by discharge to particles in a gas introduced into a gas flow pipe to form charged particles;
a charged-particle collection unit that is disposed downstream of the electric-charge generating element in a direction of a flow of the gas and collects the charged particles; and
a number detection unit that detects the number of the charged particles based on a physical quantity at the charged-particle collection unit, the physical quantity varying depending on the number of the charged particles collected by the charged-particle collection unit,
wherein the gas flow pipe has a skeleton-forming portion that is formed of a ceramic material and that is dense and a stress-relieving portion that is in contact with the skeleton-forming portion, that is formed of a material having a Young's modulus lower than a Young's modulus of the ceramic material, and that is dense.

2. A particle counter comprising:
an electric-charge generating element that adds electric charges generated by discharge to particles in a gas introduced into a gas flow pipe to form charged particles;
an excess-electric-charge collection unit that is disposed downstream of the electric-charge generating element in a direction of a flow of the gas and collects excess electric charges that have not charged the particles; and
a number detection unit that detects the number of the charged particles based on a physical quantity at the excess-electric-charge collection unit, the physical quantity varying depending on the number of the excess electric charges collected by the excess-electric-charge collection unit,
wherein the gas flow pipe has a skeleton-forming portion that is formed of a ceramic material and that is dense and a stress-relieving portion that is in contact with the skeleton-forming portion, that is formed of a material having a Young's modulus lower than a Young's modulus of the ceramic material, and that is dense.

3. The particle counter according to claim 1,
wherein the skeleton-forming portion is constituted by divided members formed by dividing the gas flow pipe into a plurality of parts, and the stress-relieving portion is a joining layer that joins the plurality of divided members together.

4. The particle counter according to claim 2,
wherein the skeleton-forming portion is constituted by divided members formed by dividing the gas flow pipe into a plurality of parts, and the stress-relieving portion is a joining layer that joins the plurality of divided members together.

5. The particle counter according to claim 3,
wherein the gas flow pipe is a quadrangular cylinder, and the divided members are formed by dividing the gas flow pipe into four parts on four sides.

6. The particle counter according to claim 4,
wherein the gas flow pipe is a quadrangular cylinder, and the divided members are formed by dividing the gas flow pipe into four parts on four sides.

7. The particle counter according to claim 1,
wherein the skeleton-forming portion is a tubular body equal in shape to the gas flow pipe, and
the stress-relieving portion is disposed as a layer at at least one of an outer surface, an inner surface, and an inner part of the tubular body.

8. The particle counter according to claim 2,
wherein the skeleton-forming portion is a tubular body equal in shape to the gas flow pipe, and
the stress-relieving portion is disposed as a layer at at least one of an outer surface, an inner surface, and an inner part of the tubular body.

9. The particle counter according to claim 1,
wherein the Young's modulus of the stress-relieving portion is not more than 0.7 times the Young's modulus of the ceramic material forming the skeleton-forming portion.

10. The particle counter according to claim 2,
wherein the Young's modulus of the stress-relieving portion is not more than 0.7 times the Young's modulus of the ceramic material forming the skeleton-forming portion.

11. The particle counter according to claim 1,
wherein the skeleton-forming portion is formed of at least one ceramic material selected from the group consisting of alumina, silicon nitride, mullite, cordierite, and magnesia.

12. The particle counter according to claim 2,
wherein the skeleton-forming portion is formed of at least one ceramic material selected from the group consisting of alumina, silicon nitride, mullite, cordierite, and magnesia.

13. The particle counter according to claim 1,
wherein the stress-relieving portion is formed of crystallized glass.

14. The particle counter according to claim 2,
wherein the stress-relieving portion is formed of crystallized glass.
